(19) United States
(12) Patent Application Publication
(10) Pub. No.: US 2008/0002539 A1
(43) Pub. Date: Jan. 3, 2008

(54) Optical disk apparatus and an alternation process method for the same

(75) Inventors: Tomoya Hoshi, Fujisawa (JP); Mitsuhiro Nishidate, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/702,815

(22) Filed: Feb. 5, 2007

(30) Foreign Application Priority Data
Jul. 3, 2006 (JP) 2006-183030

(51) Int. Cl. G11B 7/00

(52) U.S. Cl. 369/44.32

(57) ABSTRACT

An optical disk apparatus for enabling to suppress the time necessary for alternation process down to the minimum, as well as, for executing the alternation process with certainty, and also an alternation process method for that apparatus, for recording alternation information for a defect block detected within a user data recording area of an optical disk, into alternation areas of the optical disk 100, wherein during recording operation of user data, when detecting a defect block within the user data recording area on the optical disk, after executing the alternation process only on one side of alternation areas provided on both an inner periphery side and an outer periphery side of the optical disk, the alternation process is executed on a remaining alternation area, but after completing the recording operation of the user data.

### BACKGROUND OF THE INVENTION

The present invention relates to a disk recording/reproducing apparatus for recording or reproducing information onto/from a disc-like optical recording medium, such as, CD and/or DVD, etc. (hereinafter, an “optical disk”), and it relates an optical disk apparatus and an alternation process method for the same, for reducing time necessary for the alternation process, and further enabling to execute the process with certainty.

An optical disk apparatus for recording or reproducing various kinds of information onto/from a recording medium, i.e., an optical disk, such as, a CD and/or a DVD, etc., for example, is widely used as an information recording apparatus within various kinds of electronic apparatuses including, such as, a personal computer, etc. In particular, in recent years, various kinds of DVDs are spread or popularized widely, in addition to the conventional CDs, and further a HD-DVD and/or a BD, each being a recording medium having a large memory capacity, is/are under the commercialization thereof. Accompanying with this, there is a request for a disk recording/reproducing apparatus of being enable to deal with such various kinds of optical disks.

In particular, upon DVD and/or BD, accompanying with an increase of an amount or volume of information recorded on the medium, for maintaining a reliability against disk defects when recording information thereon, so-called a verify process is conducted, i.e., testing coincidence with the original data, while reading out the user data by a predetermined block unit, one after another, while recoding it thereon. If determination is made that they are not coincident with, as a result of this verify process, that block is recognized to be a defect block, and also, it is necessary to conduct a process, so-called an alternation process, i.e., recording it in an area or region (i.e., an alternation area) different from the user data recording area on the optical disk.

However, in relation to this, as described in the following Patent Document 1 or 2, for example, there is already know an optical disk apparatus, when detecting the defect flock on the optical disk during the time when recording or reproducing data thereon/from, memorizing alternation data or an address of that defect block, temporarily, within an alternation buffer memory of the apparatus, so as to be written into an alternation area and an area or region called as DMA (Defect Management Area), after completing the recording or reproducing operation of data.

[Patent Document 1] Japanese Patent Laying-Open No. 2000-339874 (2000); and

[Patent Document 2] Japanese Patent Laying-Open No. Hei 8-7485 (1996).

### BRIEF SUMMARY OF THE INVENTION

However, with such the conventional arts as mentioned above, alternation information, including the alternation data and the address information of the defect block detected on the optical disk therein, is stored into the memory, temporarily, and thereafter, when completing the writing of the data, the alternation information, being stored in the above, is written into the alternation area and the DMA area, which are provided on an inner periphery and an outer periphery of that disk, and for that reason, contents of the alternation buffer memory is lost, when a power source of the apparatus is suddenly shut down (off), or when operation of the apparatus pauses (stop) due to a shock given from an outside, etc., in particular, on the way of recording data of video or the like, continuously, on the disk; therefore, there is pointed out a drawback of losing the alternation information temporarily stored within the memory, i.e., the alternation data of the defect block and the address information thereof.

In addition, with the conventional arts mentioned above, when taking the cases of generating such defects in a large number thereof into the consideration thereof, for example, in case when a large scratch is made on the disk surface, or the like, there is a necessity of increasing the memory capacity of the alternation buffer memory to be large, for temporarily memorizing that alternation information therein, and for that reason, this results into a one of reasons of rising up the costs of the optical disk apparatus.

However, according to the standard of DVD-RAM, it is regulated that, with the defect flock detected, the same alternation information including the alternation data and the address information thereof, must be written into the alternation areas, including the DMA area therein, on the inner periphery and the outer periphery of the disk, respectively. For that reason, by taking the cases when the alternation (i.e., the defect block) occurs during the recording operation, and further the shut-off of the power source of the apparatus and also the minimization of the alternation buffer memory as mentioned above, as well, into the consideration, writing operation must be done, periodically, onto the alternation areas including the DMA area therein, on the inner periphery and the outer periphery of the disk, and for that purpose, an optical head must be moved to the inner periphery and the outer periphery of the disk, respectively. For that reason, there is a drawback of taking a long time for this alternation process.

Then, according to the present invention, an object thereof is to provide an optical disk apparatus and also an alternation process method for that, still for enabling to suppress the time necessary for the alternation process down to the minimum, although assuming that the writing operation be conducted, immediately, when alternation (i.e., the defect block) occurs during the recording operation, onto the alternation areas including the DMA area therein, while by taking the operation condition of the apparatus, which the above-mentioned conventional arts cannot treat with, into the consideration, i.e., the sudden shut-off of the power source of the apparatus, and further the minimization of the alternation buffer memory.

According to the present invention, for accomplishing the object mentioned above, firstly, there is provided an optical disk apparatus, for recording or reproducing information onto/from an optical disk, while conducting an alternation process onto an alternation area of said optical disk, for a defect block detected within a user data recording area of an optical disk, comprising: a disk motor, which is configure to rotationally drive said optical disk; a disk motor driver circuit, which is configured to drive said disk motor; an optical pickup, which is configured to irradiate a light upon a recording surface of said optical disk and also receive a reflection light thereof, thereby recording or reproducing data onto/from the recording surface of said optical disk; a slide motor, which is configured to move said optical pickup into a radial direction of the optical disk; a slide motor driver circuit, which is configured to drive said slide motor; and a controller, which is configured to control at least said disk motor driver circuit and said slide motor driver circuit upon basis of a signal supplied from said optical pickup, wherein during recording operation of user data, when detecting a defect block within the user data recording area on said optical disk, said controller, after executing the alternation process only on one side of alternation areas provided on both an inner periphery side and an outer periphery side of said optical disk, executes the alternation process on a remaining alternation area, but after completing the recording operation of said user data.

Also, according to the present invention, for accomplishing the object mentioned above, there is provided an alternation process method for an optical disk apparatus, including recording of alternation information for a defect block detected within a user data recording area of an optical disk, into alternation areas of said optical disk, wherein during recording operation of user data, when detecting a defect block within the user data recording area on said optical disk, after executing the alternation process only on one side of alternation areas provided on both an inner periphery side and an outer periphery side of said optical disk, the alternation process is executed on a remaining alternation area, but after completing the recording operation of said user data.

Further, according to the present invention, within the optical disk apparatus and the alternation process method for that, it is preferable that said alternation process is executed via a buffer memory, or preferably, during the recording operation on the user data of said optical disk, after executing said alternation process on an alternation area near to a position where the defect block is detected, between the alternation areas provided on both an inner periphery side and an outer periphery side of said optical disk, the alternation process is executed on the remaining alternation area, but after completion of the recording operation of said user data. Further, in the above, it is preferable that the alternation process interrupted is continued, when the alternation process is interrupted on the remaining alternation area.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for showing the entire structures of an optical disk apparatus, according to an embodiment of the present invention;

FIGS. 2(A) and 2(B) are views for showing the arrangement of alternation areas and the data structures thereof, on an optical disk, which can be loaded into the optical disk apparatus mentioned above;

FIG. 3 is a flow chart for showing the details of an alternation process, to be executed within the optical disk apparatus mentioned above;

FIG. 4 is a flow chart for showing the details of an alternation process, to be executed within the optical disk apparatus mentioned above, but according to other embodiment of the present invention; and

FIG. 5 is a flow chart for showing more details of the processes when a power source is shut off, which are shown in FIG. 3 or FIG. 4 mentioned above.

### DETAILED DESCRIPTION OF THE INVENTION

Hereinafter, embodiments according to the present invention will be fully explained by referring to the attached drawings.

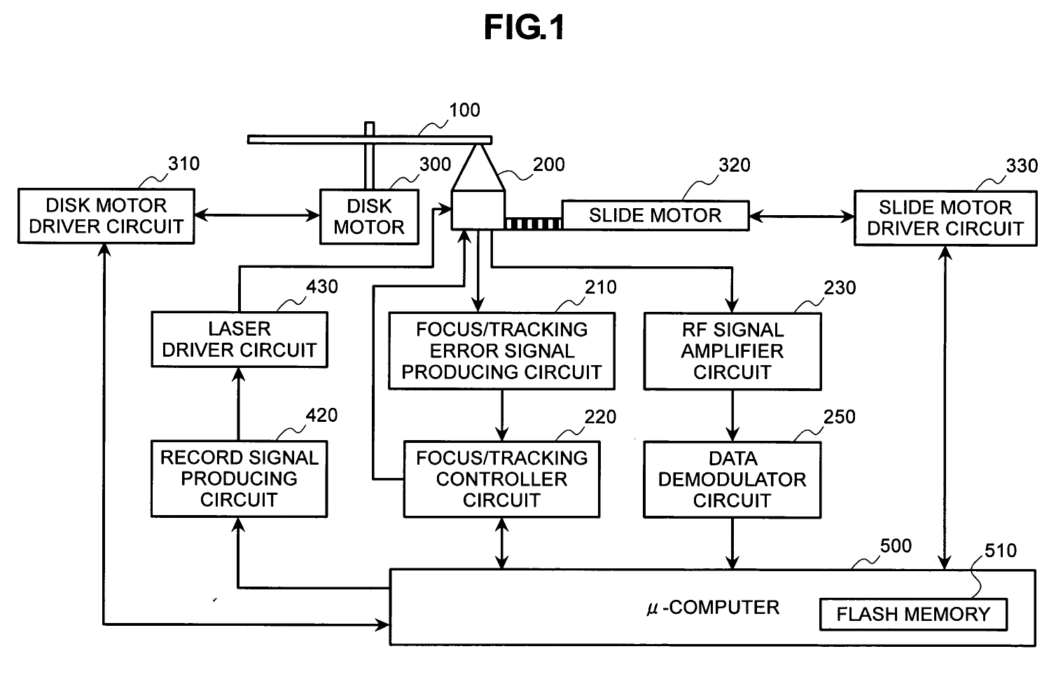

First of all, FIG. 1 attached herewith shows briefly therein the inner structures of an optical disk apparatus, according to an embodiment of the present invention, wherein a reference numeral 100 depicts so-called a disc-like optical recording medium (i.e., an optical disk), such as, DVD-RAM or the like, for example, which is loaded into that optical disk apparatus to be conducted with recording or reproducing of information thereon/from.

Also, a reference numeral 300 in this figure depicts a disk motor for rotationally driving the optical disk 100 mentioned above, and as apparent in this figure, on a turntable (not shown in the figure) attached at a tip of a rotation shaft thereof is loaded the above-mentioned optical disk 100, and thereby rotationally driving that optical disk, at a desired rotation speed. Further, this disk motor 300 is driven through a disk motor driver circuit 310, as a driving means thereof. Thus, the optical disk 100 loaded on the turntable of the disk motor 300 is controlled in the rotation speed thereof, appropriately, through the disk motor driver circuit 310, for example, in accordance with the known constant angular velocity (CAV) method or constant liner velocity (CLV) method.

Next, a reference numeral 200 in the figure depicts so-called an optical pickup, being attached to be movable in a radial direction of the optical disk 100 mentioned above, for irradiating a laser beam onto the recording surface thereof, and thereby receiving the laser beam reflected from that recording surface. Further, within an inside of this optical pickup 200, although not mentioned in the details thereof, herein, but an electric signal is reproduced from the above-mentioned laser beam reflected, and this reproduced signal is outputted into a focus tracking error signal producing circuit 210, and upon basis of that signal, a focus error signal and/or a tracking error signal is/are produced therein, for example. And, upon basis of the focus error signal and/or the tracking error signal outputted from this focus tracking error signal producing circuit 210, a focus/tracking controller circuit 220 forms a control signal to be inputted into the optical pickup 200 mentioned above, and thereby controlling the position of an objective lens (not shown in the figure), which is provided to be movable within the optical pickup 200.

Further, it is also same to the conventional art that a laser diode (not shown in the figure), as a laser beam source, which is provided within an inside of the optical pickup 200 mentioned above, is driven and also controlled in light emission intensity thereof, trough a laser driver circuit 430, for supplying driving current, upon an output of a record signal producing circuit 420, which produces a record signal shown in the figure.

Also, among electric signals, which are reproduced from the reflected laser beam within the optical pickup 200 mentioned above, so-called a RF signal is transferred into a RF signal amplifier circuit 230 for processing that RF signal to be amplified, and further it is outputted into a data demodulator circuit 250 for processing that amplified RF signal to be demodulated.

Further, within the optical pickup 200 mentioned above, there is attached a slide motor 320 for moving that optical pickup into the radial direction of the optical disk 100, and this slide motor 320 is driven/controlled through a slide motor driver circuit 330 for controlling/driving this. And, in this figure, a reference numeral 500 depicts a controller means for controlling the above-mentioned disk motor driver circuit 310, the record signal producing circuit 420, the focus/tracking controller circuit 220, and the slide motor driver circuit 330, etc., and this is constructed with a micro (μ)-computer, for example, having a buffer memory 510 in a part thereof.

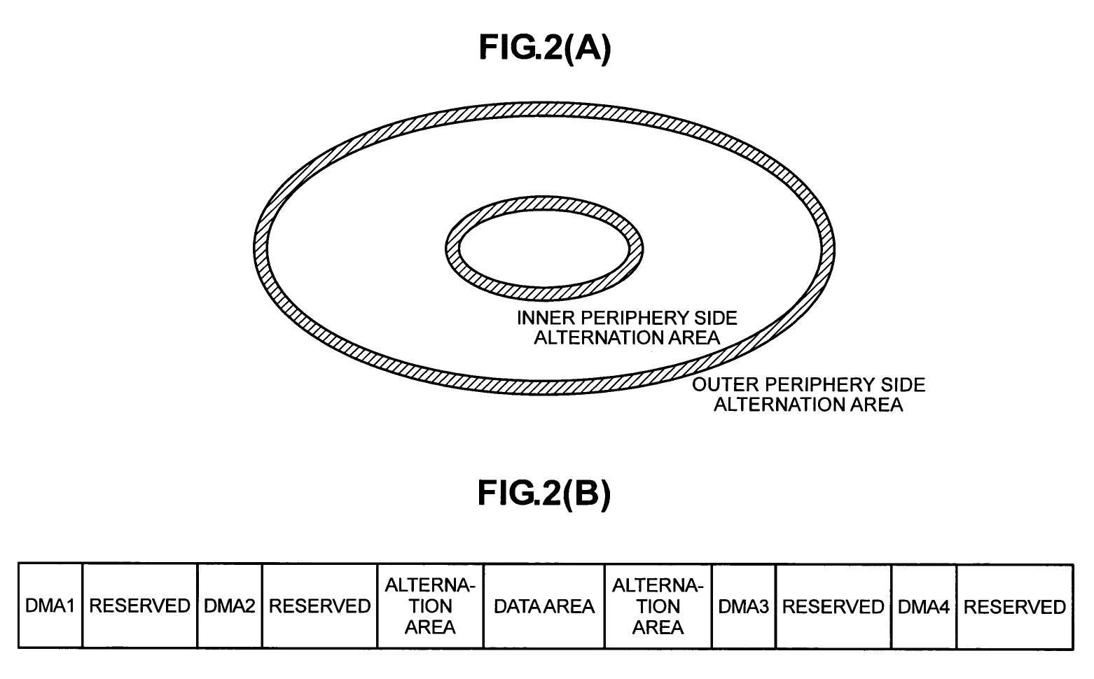

On the other hand, accompanying with the disk defects caused due to adhesion of finger prints or scratches on the recording surface thereof, for example, so-called an alternation process is executed upon the optical disk 100 mentioned above, i.e., recording the information to be recorded, from the original place of alternation to a different place, a destination of alternation (i.e., an alternation area). In this case, as is shown in FIG. 2(A) attached herewith, the optical disk has the alternation areas on both the innermost peripheral position and the outermost peripheral position on the recording surface thereof, and it also has so-called a data recording area between those inner periphery and outer periphery sides, where a user can record data therein. And, as is shown in FIG. 2(B), in each of said alternation areas, there are provided the alternation area for writing the alternation data of the defect block therein, and also a DMA area for writing the address information of it therein. In more details thereof, there are provided two (2) pieces of DMA areas and reserved areas, respectively, such as, DMA1 and DMA2 on the inner periphery side, and DMA1 and DMA2 on the inner periphery side.

Following to the above, in the structures mentioned above, for example, recording of the user data (information) is conducted while shifting the optical pickup 200 from the inner periphery side towards the outer periphery side on the optical disk 100. In more details, the microcomputer 500 mentioned above executes it while making the disk motor 300 rotate at a predetermined speed (a double-speed) or in accordance with the method (i.e., CAV or CLV, etc.) through the disk motor driver circuit 310.

Namely, within the user data recording area on the optical disk 100 mentioned above, the user data is recorded appropriately, through conducting the recording operation under the predetermined double-speed, on the other hand, that data recorded is read out, by a unit of one (1) piece or a plural number of pieces of blocks, one after another, to be tested on the coincidence with the original data (i.e., a verify process). If it is determined that those data are not same nor coincident with, as a result thereof, the said block is recognized to be the defect block, and then the microcomputer 500 executes the control for the alternation process, upon basis of that detection result. In more details thereof, the microcomputer 500 moves the optical pickup 200, trough the slide motor driver circuit 330 and the slide motor mentioned above, to the alternation area on the outermost periphery side or the innermost periphery side of the disk, thereby writing the defect block into the said alternation area, as well as, writing the address information thereof into the DMA area therein.

According to the present invention, with the writing of the alternation information, including the alternation data of the defect block detected and the address data thereof, it is executed, not into both the alternation areas on the innermost periphery and the outermost periphery of the said disk when the apparatus is under the recording operation, but only one of the alternation areas, i.e., either the innermost periphery or the outermost periphery thereof, while the writing of the alternation information into the other (i.e., the outermost periphery portion or the innermost periphery portion) is executed after completing the recording operation. However, the writing operation of the alternation information should be conducted on which side of the innermost periphery portion or the outermost periphery portion of the said optical disk, when the alternation process occurs, it is determined on the position on the disk where the writing operation is executed at present, i.e., the position of the optical pickup 200. This, in case where that position is near to the innermost periphery position of the disk, the alternation information is written into the said alternation area at the innermost periphery position, on the other hand in case where it is near to the outermost periphery position of the disk, the alternation information is written into the said alternation area at the outermost periphery position. With doing this, there is no necessity of provision of the alternation buffer memory of a large memory capacity, for storing the alternation data and the address information of the defect block detected on the disk therein, temporarily, and therefore it is possible to suppress the time necessary for the alternation process during the recording operation down to the minimum.

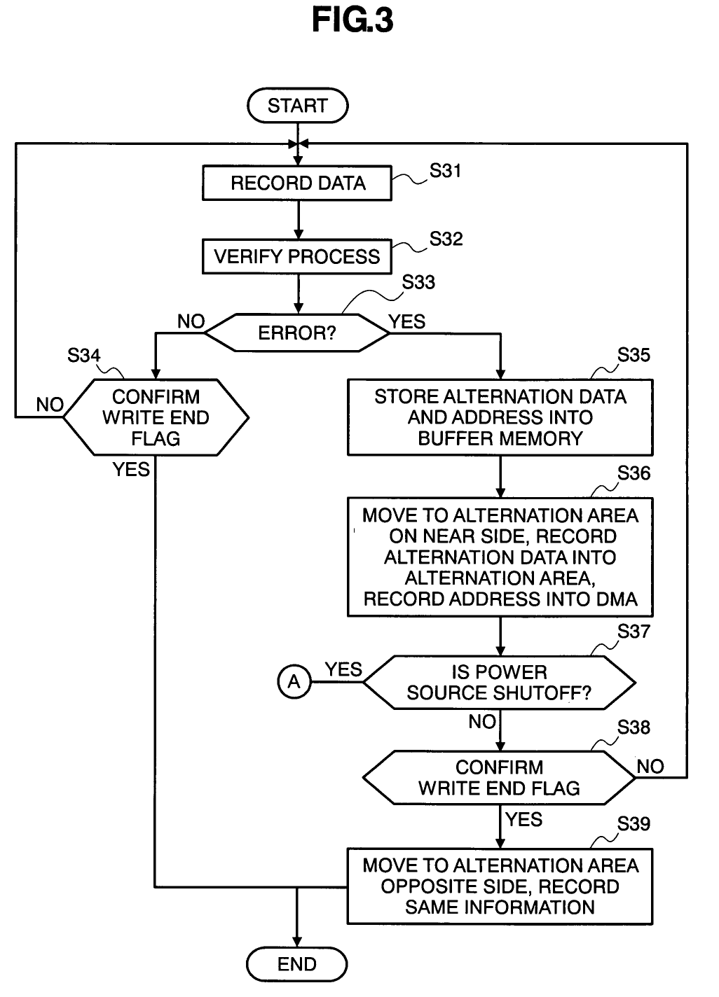

Following to the above, in FIG. 3 attached herewith is shown the operations when recording the user data, which is executed within the optical disk apparatus mentioned above, in the form of a flowchart thereof. First of all, the process is stared when the optical disk 100 is loaded into the apparatus, and the apparatus moves the optical pickup 200 into the radial direction thereof, while rotating the optical disk 100 at a predetermined rotation speed, and wherein recording of data (i.e., the user data) is conducted through irradiation of a writing laser beam upon the information recording surface of the disk (step S31). Thereafter, the verify process mentioned above (step S32) is conducted, and further, determination is made on whether there is an error or not (step S33). Thus, if it is determined that the data are same or coincident with each other (i.e., there is no error (“NO”)), in this determination, then the process makes determination on whether the recording process is ended or not, with confirmation of a write end flag; i.e., determining on whether there is the user data or not, remaining to be recorded (step S34). As a result thereof, the process is ended when determination is made that it is ended (“YES”), on the other hand when determination is made that it is not yet ended (“NO”), the process turns back to the step S31, again, thereby repeating the process mentioned above.

On the other hand, if it is determined in the determination process (step S33) mentioned above, that there is an error (i.e., “YES”), then it is recognized to be the defect block, and thereafter, the alternation process be executed, details of which will be motioned below. Thus, a unit of the alternation block and the address information thereof, being recognized to be that defect block, is stored, once into the buffer memory 510 (step S35). Thereafter, the optical pickup 200 is moved or shifted towards the alternation area on the side nearer to the blocks where the defect block is detected therein, between the alternation areas provided on both the inner periphery and outer periphery sides mentioned above, thereby writing the alternation data (step S36), which is stored within the buffer memory 510, once, as was mentioned above. In more details thereof, the unit of alternation data, which is recognized to be the defect block is recorded into the alternation area of the data area, and also the address information thereof is recorded into the DMA areas (into a plural number of areas, for example, DMA1 and DMA2, or DMA3 and DMA4)

However, herein, selection of the alternation area, on the side of which is nearer to the block where the defect block is detected, can be executed, easily and with certainty, with using the address information of the block where the said defect block is detected, or the position information of the pickup 200 at that time, for example. In more details thereof, while obtaining an intermediate position between the alternation area on the inner periphery side and the alternation area on the outer periphery side, or the address information corresponding to that intermediate position, that intermediate position is memorized into the memory of the microcomputer as the controller means, for example, to be a threshold value. Thereafter, when detecting the defect block, the position information of the optical pickup 200 or the address at that time is compared with the threshold value memorized. For instance, in case of DVD-RAM, as an example, the alternation process is conducted into the alternation area on the inner periphery side of the disk, when the defect block is detected within the blocks having the address number up to 800, while the alternation process is conducted into the alternation area on the outer periphery side thereof, when the defect block is detected within the blocks having the address number 801 or larger than that.

Thereafter, determination is made on whether the power source of the apparatus is shut off or not (step S37). As a result thereof, when it is determined that the power source is shut off (“YES”), the process shifts into a process (A), the details of which will be mentioned below, on the other hand, when it is determined that no shut-off is made on the power source (“NO”), then determination is made on whether the recording process is ended or not (step S38), through confirming the write end flag, in the similar manner to the step S34. And, as a result of this determination, if it is determined that the recording process is not completed, yet (“NO”: i.e., there is still remaining the user data to be recorded), then the above process turns back to the step S31, again, and thereby repeating the steps motioned above.

And, when determination is made that the write end flag is confirmed (“YES”), i.e., determining that the recording process is ended, in the determination process (step S38) mentioned above, then the optical pickup 200 is shifted to the alternation area on the opposite side thereto in the radial direction of the disk (for example, when determining that the alternation area on the inner periphery side is nearer, in the step S36 mentioned above, then the optical pickup is moved to the alternation area on the inner periphery side), and in the similar manner to the step S36 mentioned above, the same information is recorded into the alternation area of the said opposite side. Thus, the unit of alternation data, which is recognized to be the defect block, is recorded into the alternation area, and also the address information thereof is recorded into the DMA area (for example, into the plural number of areas, such as, DMA1 and DMA2, or DMA3 and DMA4), thereby completing a series of the steps.

Thus, with such the method for the alternation process, according to the present invention, as was mentioned above, since the alternation process is executed, every time when the defect block is detected on the disk, within the recording operation of data, it is possible to deal with the sudden shut-off of the power source of the apparatus, which cannot be dealt with the conventional arts mentioned above. And, with movement of the pickup in that instance, recording of the alternation information is conducted by moving it only to the nearer side between the alternation areas, which are provided on both the inner and outer peripheries of the disk, and thereafter the alternation process is conducted on the remaining alternation area (i.e., the area opposite thereto), under the condition that the recording operation is completed on the data (i.e., conformation of the write end flag). With doing so, it is possible to suppress the time necessary for that alternation process down to the minimum, and also to achieve the minimization of the alternation buffer, as well.

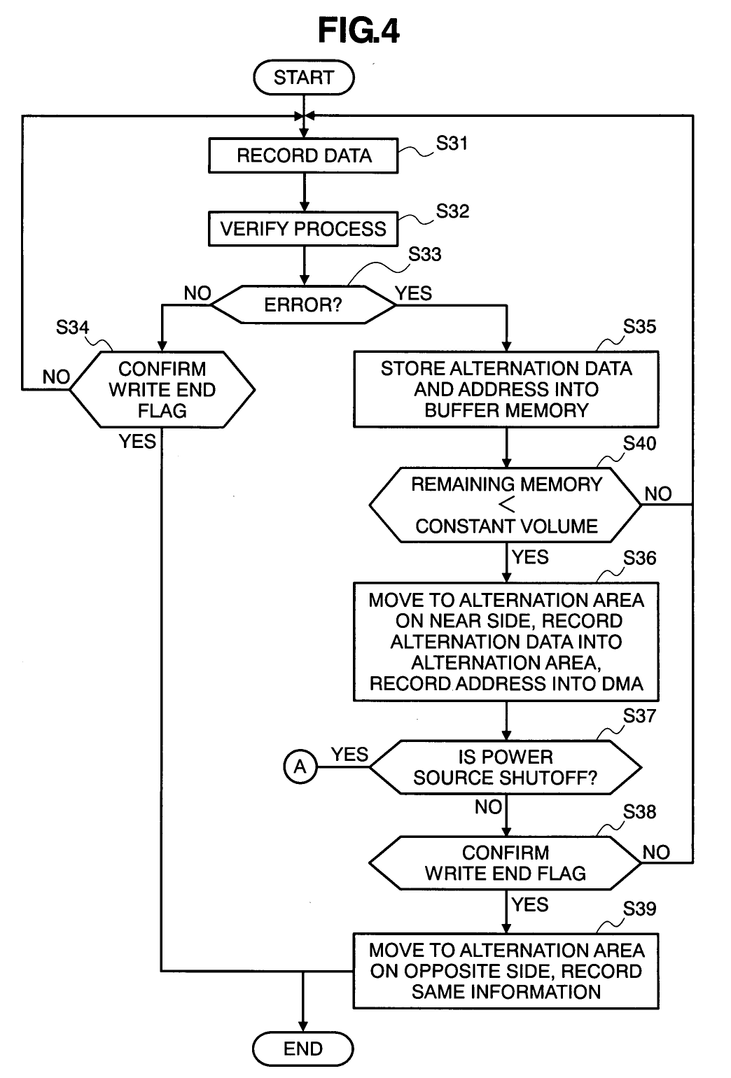

Further, in FIG. 4 attached herewith is shown the recording operation of the user data, according to other embodiment of the present invention. In this other embodiment, in addition to the process shown in FIG. 3 mentioned above, further consideration is paid onto the remaining memory capacity within the buffer memory 510 mentioned above. However, the similar steps to those shown in FIG. 3 are shown by the same reference numerals.

Thus, as apparent from this FIG. 4, in the alternation process after detecting the defect block mentioned above, in particular, after storing the unit of the alternation data and the address information thereof, which is recognized to be the said defect block, within the buffer memory 510, once (step S35), determination is made on whether the remaining recording capacity within that buffer memory is less than a predetermined value (a constant volume) or not (step S40). And, as a result thereof, if it is determined that the remaining memory capacity is not less than the constant volume (“NO”), in other words, being determined that, within the said buffer memory, there is still remaining sufficient memory capacity for storing the alternation data and address information of the detected defect block therein, temporarily, then the process turns back to the step S31 mentioned above, but not conducting the alternation process, and thereby repeating the steps mentioned above.

Thereafter, when it is determined that the remaining memory capacity within the said buffer memory is less than the constant volume (“YES”), i.e., being determined that there is not enough remaining memory capacity no more, within the said buffer memory, due to an increase of the alternation information, then the alternation process same to the above-mentioned is executed. Thus, the optical pickup 200 is moved onto the alternation area nearer thereto, thereby writing the alternation information (step S36), which is stored within the buffer memory 510, once, in the above. Thereafter, determination is made on whether the power source of the apparatus is shut off or not (step S37), and as a result thereof, in case when it is determined that the power source is shut off (“YES”), the process shifts into a process (A), the details of which will be mentioned below, on the other hand, when the power source is not shut off (“NO”), confirmation is made on the write end flag (step S38), in the similar manner. As a result of this determination, if it is determined that the recording process is not yet ended (“NO”), the process turns back to the step S31 mentioned above, and repeating the steps mentioned above, again. And, if it is determined that the write end flag is confirmed (“YES”), as a result of that determination process (step S38), the optical pickup 200 is moved towards the alternation area opposite thereto, in the radial direction of the disk, so as to record the same information onto the said alternation area of opposite side, thereby completing a series of the steps mentioned above.

However, with the method for the alternation process according to other embodiment mentioned above, it is apparent that, in the similar manner to that mentioned above, the sudden shut-off of the power source of the apparatus can be dealt with, certainly, as well as, suppressing the time necessary for that alternation process down to the minimum, and in addition thereto, further, that the alternation buffer memory can be utilized, more efficiently.

Next, hereinafter, explanation will be made about the process (i.e., the process (A)) in case when determining that the power source is shut off (“YES”), in particular, during the determination on whether the power source of the apparatus is shut off or not, which was explained by referring to the step S37.

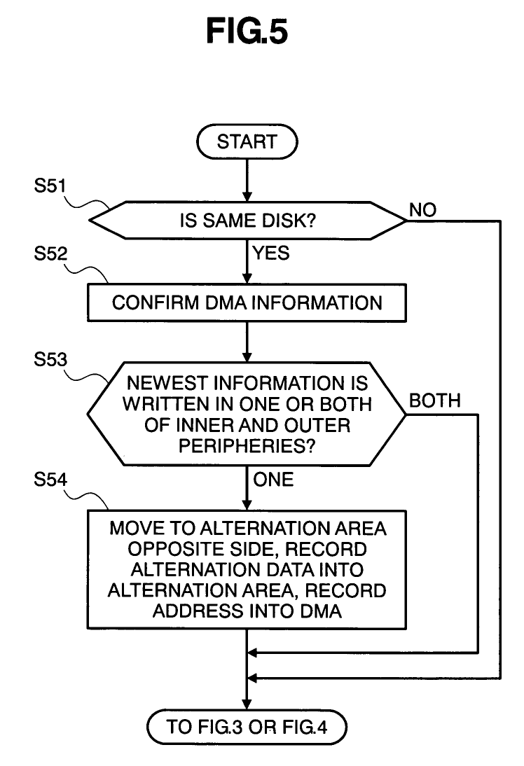

Thus, in case when it is determined that the power source is shut off (“YES”) in the step S37 mentioned above, there should be generated a case where recording is not made of the same information onto the alternation area of the opposite side, due to the reason of shut-off of that power source, irrespective of the step S38 provided for conducting the recording of the same information, thereafter, onto the alternation area of the opposite side. Thus, there occurs the case where the alternation area is interrupted on the way thereof. Then, according to the present invention, for dealing with such the shut-off of the power source as was mentioned above, there is provided a process operation, to be executed when the optical disk apparatus recovers from, after the shut-off of that power source (or, when the apparatus starts the operation, thereafter), and the details thereof will be mentioned by referring to FIG. 5 attached.

As apparent in this FIG. 5, when this process starts, first of all, determination is made on whether the optical disk loaded into the apparatus is same or not, to the optical disk, which was loaded therein when the power source is shut off (step S51). As a result of this, if determination is made that they are not same (“NO”), then the optical disk loaded into the apparatus is recognized to be that differing from the disk, upon which the alternation process is interrupted on the way, and thereby to be executed with a normal process (i.e., when recoding data thereon, the process shown in FIG. 3 or FIG. 4 be executed). However, the determination on whether the optical disk loaded therein at present is same or not to the optical disk, which was loaded therein before when the power source is shut off, it can be achieved upon basis of the information of DIZ (Disc Identification Zone), which is provided on the inner periphery portion of the disk.

On the other hand, explanation will be made hereinafter, on the process when it is determined that they are same (“YES”), in the determination process (step S51). In this case, first of all, confirmation is made of the DMA information recorded within the alternation area of the optical disk (step S52). Further, from this DMA information, it is determined on whether recording of newest information is made only on one (1) side of the alternation areas, which are provided on both the inner periphery and the outer periphery thereof, or it is conducted on both of them (step S53). As a result, in case when it is determined that the newest information is recorded on both of those areas (“BOTH”), because the alternation process is recognized to be completed when the power source is shut off within the apparatus, the normal process is executed, after completing the series of the processes mentioned above.

On the other hand, if it is determined that the newest information is recorded only on one (1) side of them (“ONLY ONE”), as a result of the determination (step S53), it can be determined that it is the disk, on which the alternation process is interrupted on the way at the time when the power source is shut off. Then, for the purpose of completing the alternation process, in the similar manner to that in the step S36 mentioned above, further, the optical pickup 200 is moved towards the alternation area of the opposite side (i.e., the optical pickup is moved towards the alternation area of the outer periphery side in case where the newest information is recorded in the alternation area on the inner periphery side, on the other hand it is moved towards the alternation area of the inner periphery side where the newest information is recorded in the alternation area on the outer periphery side), and writing the newest alternation information therein (step S54), thereby completing the series of the steps, so as to execute the normal process.

As apparent from the explanation given in the above, in accordance with the process mentioned above, even in the case where the alternation process is interrupted on the way thereof, due to the reason of the shut-off of the power source, during the execution of the alternation process shown in FIG. 3 or FIG. 4 mentioned above, it is possible to continue it, thereby completing the necessary alternation process thereafter; therefore, it is possible to deal with the sudden shut-off of the power source within the apparatus and to suppress the time necessary for that alternation process down to the minimum, and in addition thereto, further it is possible to execute the alternation process, with certainty.

As apparent from the above, according to the present invention, there can be obtained a superior effect of providing the optical disk apparatus and also the alternation process method for that, still for enabling to suppress the time necessary for the alternation process down to the minimum, although assuming that the writing operation be conducted, immediately, when alternation (i.e., the defect block) occurs during the recording operation, into the alternation areas including the DMA area therein, by taking into the consideration, the operation condition of the apparatus, which the above-mentioned conventional arts cannot treat with, i.e., the sudden shut-off of the power source of the apparatus, and further the minimization of the alternation buffer memory, and thereby enabling to execute the alternation process with certainty.

While we have shown and described several embodiments in accordance with our invention, it should be understood that disclosed embodiments are susceptible of changes and modifications without departing from the scope of the invention. Therefore, we don not intend to be bound by the details shown and described herein but intend to cover all such changes and modifications that fall within the ambit of the appended claims.

What is claimed is:

1. An optical disk apparatus, for recording or reproducing information onto/from an optical disk, while conducting an alternation process onto an alternation area of said optical disk, for a defect block detected within a user data recording area of an optical disk, comprising:
a disk motor, which is configure to rotationally drive said optical disk;
a disk motor driver circuit, which is configured to drive said disk motor;
an optical pickup, which is configured to irradiate a light upon a recording surface of said optical disk and also receive a reflection light thereof, thereby recording or reproducing data onto/from the recording surface of said optical disk;
a slide motor, which is configured to move said optical pickup into a radial direction of the optical disk;
a slide motor driver circuit, which is configured to drive said slide motor; and
a controller, which is configured to control at least said disk motor driver circuit and said slide motor driver circuit upon basis of a signal supplied from said optical pickup, wherein
during recording operation of user data, when detecting a defect block within the user data recording area on said optical disk, said controller, after executing the alternation process only on one side of alternation areas provided on both an inner periphery side and an outer periphery side of said optical disk, executes the alternation process on a remaining alternation area, but after completing the recording operation of said user data.

2. The optical disk apparatus, as described in the claim 1, further comprising:
a buffer memory, wherein
said controller executes said alternation process, with using said buffer memory.

3. The optical disk apparatus, as described in the claim 1, wherein said controller, after executing said alternation process on the alternation area near to a position where the defect block is detected, between those alternation areas provided on both an inner periphery side and an outer periphery side of said optical disk, executes the alternation process on the remaining alternation area, but after completing the recording operation of said user data.

4. The optical disk apparatus, as described in the claim 1, wherein said controller has a function of continuing the alternation process interrupted, when said alternation process is interrupted within said remaining alternation area.

5. An alternation process method for an optical disk apparatus, including recording of alternation information for a defect block detected with in a user data recording area of an optical disk, into alternation areas of said optical disk, wherein
during recording operation of user data, when detecting a defect block within the user data recording area on said optical disk, after executing the alternation process only on one side of alternation areas provided on both an inner periphery side and an outer periphery side of said optical disk, the alternation process is executed on a remaining alternation area, but after completing the recording operation of said user data.

6. The alternation process method for an optical disk apparatus, as described in the claim 5, wherein said alternation process is executed via a buffer memory.

7. The alternation process method for an optical disk apparatus, as described in the claim 5, wherein during the recording operation on the user data of said optical disk, after executing said alternation process on an alternation area near to a position where the defect block is detected, between the alternation areas provided on both an inner periphery side and an outer periphery side of said optical disk, the alternation process is executed on the remaining alternation area, but after completion of the recording operation of said user data.

8. The alternation process method for an optical disk apparatus, as described in the claim 5, wherein the alternation process interrupted is continued, when the alternation process is interrupted on the remaining alternation area.
